(19) United States
(12) Patent Application Publication
(10) Pub. No.: US 2006/0119707 A1
(43) Pub. Date: Jun. 8, 2006

(54) Personal video message system

(76) Inventors: John Douglas Merrell, Noblesville, IN (US); Timothy Joseph Tully Jr, Noblesville, IN (US)

Correspondence Address: THOMSON LICENSING INC., PATENT OPERATIONS, PO BOX 5312, PRINCETON, NJ, 08543-5312, US

(21) Appl. No.: 10/527,577

(22) PCT Filed: Sep. 9, 2003
(86) PCT No.: PCT/US03/28211

§ 371 Date: Mar. 11, 2005

Related U.S. Application Data
(60) Provisional application No. 60/410,097, filed on Sep. 12, 2002.

(51) Int. Cl. H04N 5/225; H04N 9/04

(52) U.S. Cl. 348/207.99; 348/373

(57) ABSTRACT

There is provided a video message system that includes a video display, a frame, and at least one video camera. The video display, which has a fixed position, plays back a video portion of a video message from a user. The frame frames the video display. The at least one video camera is disposed on the frame, and is oriented in the same direction as the video display, for capturing video data of the user for inclusion in the video portion of the video message.

### FIELD OF THE INVENTION

The present invention generally relates to personal video recorders (PVR) and, more particularly, to a fully integrated personal video message system.

### BACKGROUND OF THE INVENTION

Video recording systems such as Personal Video Recording (PVR) systems and Digital Video Recording (DVR) systems currently allow a user of such systems to record programming events to a hard drive (e.g., as a recorded event) or to a storage buffer. The video source for such systems is generally a television, cable or other broadcast source.

Video conferencing systems allow a user to transmit his or her video images (as well as corresponding audio) to other users that are remote from the user via a camera connected to a computer and directed at the user, and corresponding software that allows the transmission of such information.

Camcorders are designed for recording audio and video data of a subject that is located on an opposing side of the camera from where the photographer is located. That is, the viewfinder used by the photographer to identify and frame the subject is located opposite the side of the camera where the lens that captures the video data is disposed. The non-fixed, multi-position Liquid Crystal Displays (LCDs) of newer camcorders make holding such camcorders easier for the photographer, but are not well situated for enabling the photographer to record video images of him or herself without the use of a tripod and remote control system.

The drawback of the aforementioned technologies is that no such system exists whereby a user can leave personal video message for a family member or friend using a single integrated device.

### SUMMARY OF THE INVENTION

The problems stated above, as well as other related problems of the prior art, are solved by the present invention, a personal video message system.

According to an illustrative embodiment of the present invention, there is provided a video message system that includes a video display, a frame, and at least one video camera. The video display, which has a fixed position, plays back a video portion of a video message from a user. The frame frames the video display. The at least one video camera is disposed on the frame, and is oriented in the same direction as the video display, for capturing video data of the user for inclusion in the video portion of the video message.

These and other aspects, features and advantages of the present invention will become apparent from the following detailed description of preferred embodiments, which is to be read in connection with the accompanying drawings.

### BRIEF DESCRIPTION OF THE DRAWINGS

FIG. 1 is a block diagram of the personal video message system 100 according to an embodiment of the invention;

FIG. 2 is a block diagram representing various button sets shown in FIG. 1; and

FIG. 3 is a block diagram of the personal video message system 300 according to another embodiment of the invention.

### DETAILED DESCRIPTION OF THE INVENTION

The present invention is directed to a personal video message system. The present invention may be used to record personal messages having video content and, optionally, also audio content. Advantageously, the present invention integrates a video camera, a microphone, a display, and speakers into a frame (e.g., similar to a picture frame) or desktop/set top box to allow a user to record a message having video and audio content with requiring a camera operator or a tripod.

It is to be understood that the present invention may be implemented in various forms of hardware, software, firmware, special purpose processors, or a combination thereof. Preferably, the present invention is implemented as a combination of hardware and software. Moreover, the software is preferably implemented as an application program tangibly embodied on a program storage device. The application program may be uploaded to, and executed by, a machine comprising any suitable architecture. The unit may be implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof) which is executed via the operating system. In addition, various other peripheral devices may be connected to the computer platform such as an additional data storage device and a printing device.

It is to be further understood that, because some of the constituent system components and method steps depicted in the accompanying Figures are preferably implemented in software, the actual connections between the system components (or the process steps) may differ depending upon the manner in which the present invention is programmed. Given the teachings herein, one of ordinary skill in the related art will be able to contemplate these and similar implementations or configurations of the present invention.

The personal video message system according to the present invention would allow a person to leave an audio-video message for retrieval as, for example, a personal family message, a self-reminder message, or an informational message. The operator/user would only need to stand in front of the system (and face a video display and a camera) and record a message for either immediate playback or later retrieval. In one embodiment of the present invention, the physical structure of the system (similar to a picture frame, but with a screen (e.g., LCD) within the frame instead of a photograph) lends itself to framing the subject while recording to ensure proper position of the subject with respect to the camera (e.g., in front of the camera, within the pre-set/known focus range of the camera, and so forth). During recording, the system is capable of displaying the remaining recording time (e.g., in the form of a countdown timer), and a date/time stamp. During a playback session, the time remaining per message block (multiple messages would be possible up to the memory/recorded storage maximum) can be displayed on the video display.

The elements of the personal video message system (e.g., camera, memory device, processor, and so forth) could also be built into a set-top box, with audio/video outputs. This would allow the invention to be combined with a personal video recorder, personal computer, or other storage/playback device. Moreover, such an implementation can provide remote message storage and retrieval (internet, broadband, telephone, etc). In such a case, the personal video message system could be implemented such that the messages are stored remote there from on another device connected there to. A remote access feature, particularly with respect to the set top and related implementations, could allow for remote retrieval of message from a source other than the personal video message system.

It is to be appreciated that in the case that the present invention is implemented as a set top box, then the present invention may omit having its own video display, instead using the video display of a television or monitor located nearby in place of or even in addition to its own video display.

A message-delay feature may be employed to delay notification/playback of the message until a pre-specified time. Such time may be entered at the time of the recording of the message. Thus, for example, a birthday greeting can be recorded prior to a business trip that is to take place on the birthday, so as to provide a timely playback of the birthday greeting. Such feature may be implemented, for example, using a date/time stamp that would be read and processed by a microprocessor that controls delayed notification. Moreover, such feature, like the other features of the personal video message system, may be combined so that, for example, the playback of a message may be delayed using the message-delay feature and when the message is ultimately played the message is first retrieved from a remote storage location using the remote access feature. It is to be appreciated that the message delay feature may be employed to record a message from one parent to go another and mark the message so that a notification of that the message is pending is not provided until a time period when it is known that children are not around (e.g., school time). Many other applications may be readily determined by one of ordinary skill in the art for use with this and the other features of the present invention.

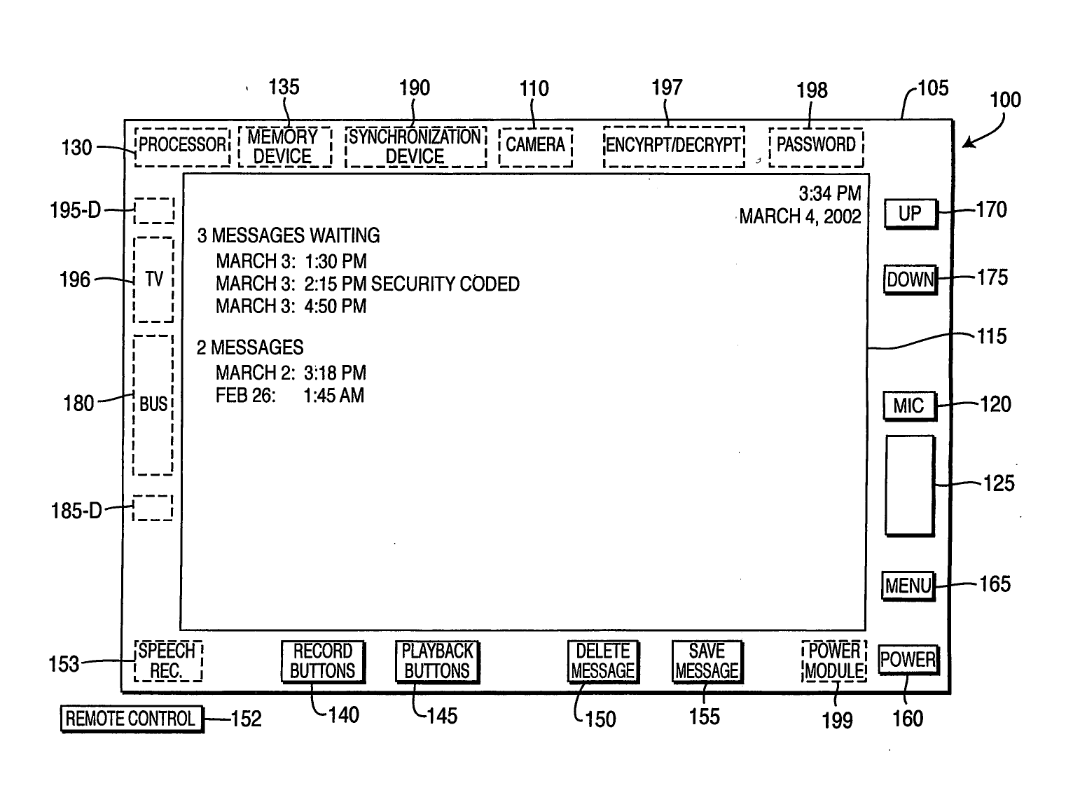

FIG. 1 is a block diagram of the personal video message system 100 according to an embodiment of the invention.

The personal video message system 100 includes a frame 105, at least one camera (hereinafter “camera”) 110, a video display 115, at least one microphone (hereinafter “microphone”) 120, at least one speaker (hereinafter “speaker”) 125, at least one processor (hereinafter “processor”) 130, a memory device 135, a group of record buttons 140, a group of playback buttons 145, a “delete message” button 150, a “save message” button 155, a power button 160, a menu button 165, an increase volume button 170, a decrease volume button 175, an external bus 180, a message indicator 185, a synchronization device 190, a timer 195, a TV tuner 196, an encryption/decryption device 197, password manager 198, a power module 199, and a speech recognition unit 153. An internal bus (not shown) couples the preceding elements together within frame 105. The internal bus may include signal (e.g., data) and power lines. A remote control 152 may be used to control and interact with the personal video message system 100.

The frame 105 may be similar to a picture-type frame (such as that used for pictures and photographs). Moreover, the frame 105 may include a multi-layered bezel around the video display 115. That is, the surface of the frame 105 where the camera 110 and microphone 120 are located need not have the same depth as the video display with respect to the front of the personal video message system 100. The camera 110 and microphone 120 may be slightly offset back or forward of the actual video display surface, or even angled on surfaces that are located behind or in front of the plane of the actual video display surface. Given the teachings of the present invention provided herein, one of ordinary skill in the related art will contemplate these and various other implementations of a frame and/or housing for enclosing, surrounding, or otherwise relating to the video display 115 and possibly other elements of the personal video message system 100.

The video display 115 is disposed within the frame 105, and the camera 110 is disposed on the frame 105, such that both the video display 115 and the camera 110 face the user. The video display be implemented using any video display technology including, but not limited to, Liquid Crystal Display (LCD), Digital Light Processing (DLP), Cathode Ray Tube (CRT), plasma, and so forth.

The camera 110 captures video data of the user for inclusion in a video portion of a video message. Preferably, although not necessarily, the camera 110 includes a wide-angle fixed-focus lens for ease of implementation. The video display 115 plays back the video portion of the video message, for the user or for others.

Moreover, it is preferable that the video display 115 displays a current position of the user immediately prior to actual initiating the recording of video data to ensure that the user is in the proper position for video capture. While the use of a preset distance between the user and the lens of the camera 110 may also be employed for this purpose, confirmation can nonetheless be quickly provided by the to user verifying his or her proper positioning with respect to the camera 110 by looking at a screen of the video display 115. This pre-recording verification of position may be provided, for example, by a pre-selected time delay (e.g., 5 sec) that is automatically imposed when a user actuates a record button, to allow the user time to get into and verify the proper position for the message prior to any actual recording.

The microphone 120 captures audio data of the user for inclusion in an audio portion of the video message. The speaker 125 plays back the audio portion of the video message. The synchronization device 190 synchronizes the playback of the video portion of the message with the audio portion of the message. While shown in FIG. 1 as a separate element, the function performed by the synchronization device 190 may subsumed by the processor 130. Moreover, the synchronization device 190 may also be used to perform delay functions. Alternatively, a separate delay element may be employed.

The message, that is, the captured video data and audio data, is stored in the memory device 135. Moreover, video and audio processing applications may also be stored in the memory device 135. Such applications may be used to compress, decompress, and otherwise process the captured video and audio data. For example, one or more software codecs may be stored in memory device 135 for compressing and decompressing the video and audio data. The message may be stored using any format including, but not limited to, MPEG format.

Moreover, applications directed to features of the personal video message system 100 other than message storage may also be stored in the memory device 135 for execution by the processor 130, or may be implemented as separate dedicated devices. In a preferred embodiment of the present invention, the data stored in memory device 135 (or even in some other memory (not shown) of the personal video message system 100) is capable of being upgraded via connection to a computer or other device. In this way, upgrades to the personal video message device 100 (e.g., to features thereof) may be readily obtained, for example, from the Internet and then transferred to the personal video message device 100 via the computer.

The message indicator 185 provides an indication that a new message is pending and may be implemented as, for example a light (e.g., Light Emitting Diode (LED)) or other type of indicator including other visual and/or audio indicators. Optionally, the message indicator 185 may also provide an indication that an old message is currently stored in the memory device. The latter may be accomplished via a separate light included in the message indicator or by some other device. The number of messages may be represented by the number of times the light flashes within a pres-specified time period. Alternatively, one or more numerals may be provided to the user by the message indicator 185, such that a first numeral indicates the number of new messages and a second numeral indicates the number of old saved messages. Further, additional information may be displayed about any of the messages, including messages already played back and messages not already played back. The information may include, for example, the time and date when the message was recorded, whether it is encrypted, and so forth. Moreover, personal video message system 100 may be configured such that video display 115 always displays the current date and/or time of day in some portion of the screen.

The processor 130 controls the functions of the personal video message system. User inputs, besides the audio and video data, are provided through the various buttons and other user interfaces disposed on the frame 105.

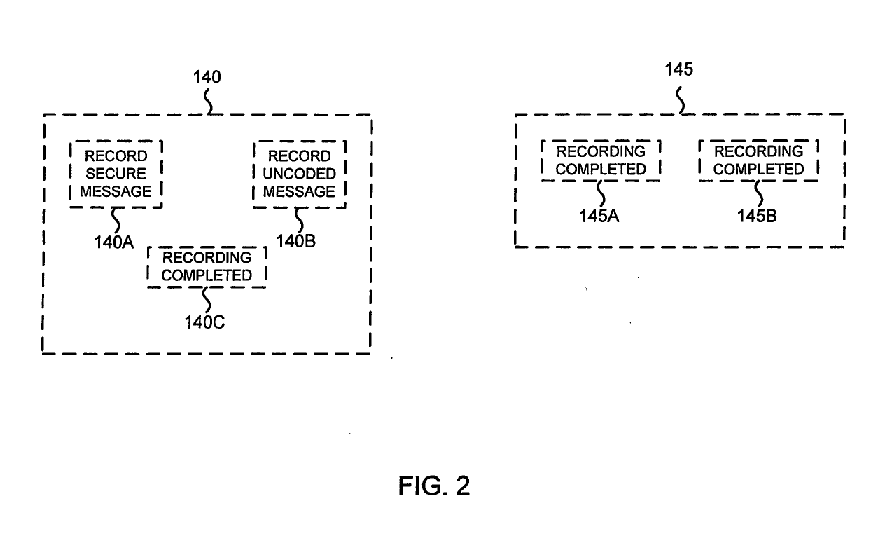

FIG. 2 is a block diagram representing various button sets shown in FIG. 1. The group of record buttons 140 include a “record secure message” button 140a, a “record uncoded message” button 140b, and a “recording completed” button 140c (see FIG. 2). The record secure message button 140a is for initiating the recording of a message that is encrypted for security or other purposes. The record uncoded message button 140a is for initiating the recording of a message that is not encrypted. The recording completed button 140c is for terminating a recording section. The recording completed button 140c may be used to terminate a recording section prior to any pre-specified time outs, if any, due to any criteria (e.g., limited memory).

The group of playback buttons 145 include a “playback old message” button 145a and a “playback new message” button 145b (see FIG. 2). The playback old message button 145a is for playing back a message, e.g., that has already been played back at least one once. The playback new message button 145b is for playing back a message that has not yet been played back since being recording.

The “menu” button 165 is for activating a menu system that provides a series of menus that may be cycled through via, e.g., the other buttons (e.g., the volume button for up and down and any other button for making a selection).

The “delete message” button 150 is for deleting a message. The actual message that is deleted when the button 150 is actuated may be one that is currently playing and, if in menu system is activated, the message may be one that is not currently playing but that was previously stored. In the latter case, the message will be indexed in a manner that makes quick identification possible. This may involve, for example, an alphabetical naming system, an alphanumeric naming system, some other symbol representation system (e.g., different symbols to represent different family members that can leave the messages), and/or any other known approaches to readily identifying The “save message” button 155 is for saving a message that is currently playing.

The power button 160 is for turning on/off power to the personal video message system 100. The power module 199 may be directed to conventional batteries, rechargeable batteries, and/or wired power and may include the corresponding elements of such as readily determined by one of ordinary skill in the related art.

During recording of a video message, the captured video may be displayed on the video display 115 so that the user can concurrently verify the content of the video message while recording the same. Moreover, during recording of the video message, timer 195 is used in conjunction with video display 115 to display a countdown timer that specifies the time remaining for recording a given message. This is particularly useful when only a certain amount of memory is available to record a message such as when the memory device 135 is almost full or when pre-designated time periods are used for message recording.

Password manager 198 may employ a limited-access message-retrieval feature so that a special retrieval code would be required to access confidential messages. In this way, e.g., personal messages between spouses may be kept from a child or other party attempting to view the same. The same or higher priority confidential messages could be flagged as such by actuating a pre-designating one of the buttons or a dedicated button (not shown) so that they may be encrypted/decrypted by encryption/decryption device 197 and not simply blocked from access by password manager 198.

The TV tuner 199 and external bus 180 allow for television, satellite, and/or cable television broadcasts to be received and displayed on the personal video message system 100. In this way, even greater utility and space savings can be provided in areas of a home or office that traditionally are not too expansive such as, for example, the kitchen.

Moreover, the external bus 180 allows for video and audio to be played from other sources on the personal video message system 100 such as, but not limited to, Compact Disks (CDs), radio, Digital Video Disks (DVDs), and so forth.

The speech recognition module 153 may be included in the personal video message system 10 to facilitate hands-free operation of a phone feature (for placing and receiving phone calls) included in the personal video memory system or for controlling and interacting with the personal video memory system 100.

A brief description will now be given of some other features of the personal video message system 100. The personal video message system 100 may include an ALERT GUARD module for providing video messages for playback that involve general alerts from, e.g., local, state, and/or federal governments and their agents regarding, e.g., emergencies and other items of concern. The ALERT GUARD module may receive/download data transmissions (e.g., digital data and/or analog data) that include text and video data to be decoded and played back. The personal video message system 100 may include a visual graphic generated kaleidoscope from the audio signal when the unit is in stand-by or in an audio-only mode. Moreover, the personal video message system 100 may include a pre-programmed, but randomly generated, daily visual “fortune cookies” on the screen of the video display 115. Additionally, the personal video message system 100 may include a daily scheduler. Further, the daily scheduler may include pre-programmed visual thoughts for the day, or daily still photography that provides screen savers. Also, the personal video message system 100 may include access to a random 6-digit numeric display for lotto players, or a visual casino slot machine. Many of the preceding features may be implemented as software and readily added and/or removed from the personal video message system 100 as desired. In addition, the personal video message system 100 may be used, via the external bus 180, to download photographic images such as, e.g., from “family share” web providers or other sources. The photographic images may be displayed on video display 115. Moreover, the personal video message system 100 may include a remote control device including, e.g., a wireless remote keyboard (not shown) for Internet access or for otherwise controlling the system 100. Also, the personal video message system 100 may be employed as a hands-free phone, using the display area for incoming call screening and as an on-screen memory log of telephone numbers (which may also be stored in memory device 135).

Preferably, the personal video message system 100 of the present invention is mounted on the front of a refrigerator, a central hub in any household, to provide the most readily accessible location for leaving and retrieving messages, as well as other attendant features of the present invention such as broadcasting television signals.

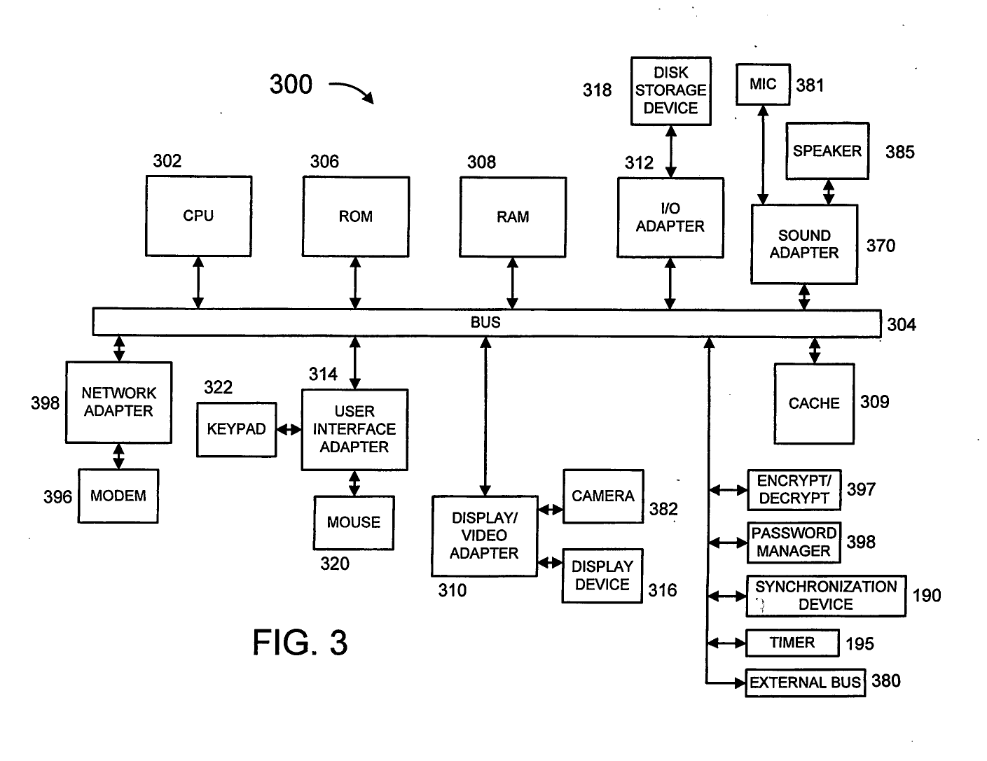

FIG. 3 is a block diagram of the personal video message system 300 according to another embodiment of the invention. The personal video message system 300 of FIG. 3 is particularly suited for implementation in a set top unit or in a computer system (e.g., PC, and so forth).

The personal video message system 300 includes at least one processor (CPU) 302 operatively coupled to other components via a system bus 304. A read only memory (ROM) 306, a random access memory (RAM) 308, a display/video adapter 310, an I/O adapter 312, a user interface adapter 314, a sound adapter 399, and a network adapter 398, are operatively coupled to the system bus 304.

An encryption/decryption device 397, a password manager 398, a synchronization device 190, and a timer 195 are coupled to processor 302 by system bus 304.

A video display 316 and a camera 382 are operatively coupled to system bus 304 by display/video adapter 310. A disk storage device (e.g., a magnetic or optical disk storage device) 318 is operatively coupled to system bus 304 by I/O adapter 312.

A mouse 320 and keypad and/or keyboard (hereinafter “keypad”) 322 may be operatively coupled to system bus 304 by user interface adapter 314. The mouse 320 and keypad 322 are used to input and output information to and from system 300. The keypad 322 may include various dedicated buttons such as those described above for activating the many features of the personal video message to system 300.

At least one speaker (herein after “speaker”) 397 and a microphone or other sound/speech transducer (hereinafter “microphone”) 381 are operatively coupled to system bus 304 by sound adapter 399.

A (digital and/or analog) modem 396 is operatively coupled to system bus 304 by network adapter 398.

An external bus 380 is coupled to system bus 304 to allow remote retrieval of messages and playing back of other media sources. External bus 380 may include RCA connectors, S-Video connectors, component video connectors, fiber optic connectors, and various other video and audio connectors to allow media from other to devices (e.g., Compact Disks (CDs), Digital Versatile Disks (DVDs), radio, TV, and so forth) to be played back on the personal video message system 300. Some of these other types of components may even be integrated within the personal video message system 100 itself (e.g., CD player, TV tuner, etc.). A message indicator 385 may be integrated within video display 316 (e.g., LCD) to functions as described above with respect to personal message video system 100 shown in FIG. 1.

It is to be appreciated the elements shown in FIGS. 1-3 are for illustrative purposes and, thus, other elements may be omitted, included, and/or substituted, as is required by one of ordinary skill in the related art. That is, given the teachings of the present invention provided herein, one of ordinary skill in the related art will contemplate these and various other configurations and implementations of a personal video message system according to the present invention while maintaining the spirit of the present invention.

A description will now be given of some of the many attendant advantages of the present invention. For example, the integration of the above-mentioned video messaging features into single device eliminates set-up problems between the camera and visual playback screen. Such set-up problems may include, for example, determining and/or maintaining a proper distance between the subject (user) and the camera lens. Moreover, the integration also provides the ability to have a “fixed” performance level for the photo imager and/or camera lens by securing and positioning the photo imager and/or camera lens in a preset location from the image or person being recorded. In this way, blurry out-of-focus shots can be eliminated when the subject being recorded is at the proper distance from the lens and corresponding camera elements. Further, integration of the preceding features with those capable of receiving and displaying television signals and the like provide additional flexibility and benefits as described above.

Although the illustrative embodiments have been described herein with reference to the accompanying drawings, it is to be understood that the present invention is not limited to those precise embodiments, and that various other changes and modifications may be affected therein by one of ordinary skill in the related art without departing from the scope or spirit of the invention. All such changes and modifications are intended to be included within the scope of the invention as defined by the appended claims.

1. A video message system, comprising:
a video display, having a fixed position, for playing back a video portion of a video message from a user;
a frame for framing said video display; and
at least one video camera disposed on said frame, and oriented in a same direction as said video display, for capturing video data of the user for inclusion in the video portion of the video message.

2. The video message system of claim 1,
further comprising:
a microphone for capturing audio data from the user for inclusion in an audio portion of the video message; and
at least one speaker for playing back the audio portion of the video message.

3. The video message system of claim 2, further comprising a synchronization device for providing synchronization data for synchronizing the playback of the audio portion with the playback of the video portion.

4. The video message system of claim 1, wherein said video display is further for displaying information corresponding to at least one of the recording and the playing back of the video message.

5. The video message system of claim 1, further comprising a memory device, disposed with said frame, for storing the video message.

6. The video message system of claim 5, wherein said memory device is capable of being dynamically updated.

7. The video message system of claim 1, wherein said frame is a picture-type frame.

8. The video message system of claim 7, wherein said frame comprises a plurality of bezels, at least one of said bezels for having said video display disposed thereon.

9. The video message system of claim 1,
further comprising:
a microphone for capturing audio data from the user for inclusion in an audio portion of the video message; and
at least one speaker for playing back the audio portion of the video message,
wherein said frame comprises a plurality of bezels, at least one of said bezels for having said video display and said microphone disposed thereon.

10. The video message system of claim 1, further comprising an encryption/decryption device for encrypting and decrypting the video message.

11. The video message system of claim 1, further comprising:
a user input device for receiving a pre-designated message retrieval code from a user; and
a password manager for blocking access to the message until the pre-designated message retrieval code provided by the user is verified.

12. The video message system of claim 11, further comprising an encryption/decryption device for encrypting and decrypting the video message.

13. The video message system of claim 11, further comprising a delay module for receiving a delay input that delays a notification of the video message until a specified time.

14. The video message system of claim 13, wherein the specified time corresponds to a known time period when children are remote from the video message system.

15. The video message system of claim 1, wherein said at least one camera comprises at least two camera for captured stereoscopic video data of the user.

16. The video message system of claim 1, further comprising a processor for graphically generating a visual kaleidoscope for display on said display device.

17. The video message system of claim 1, further comprising:
a memory device for storing a plurality of visual fortune cookies; and
a processor for randomly selecting a visual fortune cookie from among the plurality of visual fortune cookies for display on said display device.

18. The video message system of claim 1, further comprising a daily scheduler.

19. The video message system of claim 1, further comprising a visual casino slot machine that is displayed on said display device.

20. The video message system of claim 1, further comprising a remote control device for controlling functions of the video message system.

21. The video message system of claim 1, further comprising a telephone feature for placing and receiving telephone calls.

22. The video message system of claim 1, further comprising a message indicator for indicating an existence of unplayed video messages.

23. The video message system of claim 22, wherein said message indicator is further for indicating an existence of saved video messages that have been already played back at least once.

24. The video message system of claim 1, further comprising an external bus for at least one of connecting to an external device to retrieve the video message there from or to receive remote instructions for retrieving the video message.

25. The video message system of claim 1, further a delay module for receiving a delay input that delays a notification of the video message until a specified time.

26. The video message system of claim 25, further comprising an external connector for receiving the delay input from a remote location with respect to a location of the video message system.

27. The video message system of claim 1, further comprising a timer for time-stamping messages as they are recorded.

28. The video message system of claim 1, further comprising a timer for specifying a time amount remaining for recording the video message.

29. The video message system of claim 1, further comprising a timer for specifying a time amount remaining of a current playback of the video message.
